(19) United States
(12) Patent Application Publication
(10) Pub. No.: US 2026/0080257 A1
(43) Pub. Date: Mar. 19, 2026

(54) SIMULATION-BASED PLATFORM FOR DEVELOPMENT, TESTING, AND DEPLOYMENT OF LARGE LANGUAGE MODELS AND AI AGENTS

(71) Applicant: Jazmia Henry, Seattle, WA (US)

(72) Inventor: Jazmia Henry, Seattle, WA (US)

(21) Appl. No.: 18/889,945

(22) Filed: Sep. 19, 2024

(51) Int. Cl. G06N 3/092; G06N 3/047

(52) U.S. Cl. CPC G06N 3/092; G06N 3/047

(57) ABSTRACT

The present invention provides a system and method for developing, testing, and deploying artificial intelligence (AI) agents within a simulation environment. The system includes a simulation environment that manages states and transitions, an AI agent that interacts with this environment, and a wrapper that facilitates data conversion between the two. Modular components decompose the agent's behavior, while various execution modes optimize their processing. Error handling mechanisms detect and manage system exceptions, and a configuration module sets up parameters and initializes components. Input/output processing ensures compatibility between simulation data formats, and a logging module records interactions for analysis. API integration extends the AI agent's capabilities through external services. This flexible framework enables the AI agent to learn, adapt, and optimize its performance across diverse applications.

### FIELD OF THE INVENTION

The present invention relates to the field of artificial intelligence (AI), specifically to the development, testing, and deployment of large language models (LLMs) and AI agents. It encompasses methods and systems for creating realistic and customizable simulation environments that facilitate training, testing, and evaluation of AI models across various industries, with a focus on improving adaptability, robustness, security, and ethical compliance.

### BACKGROUND

The rapid advancement of artificial intelligence (AI) technologies, particularly large language models (LLMs) and AI agents, has driven significant progress in various domains, including natural language processing, autonomous systems, and decision-making applications. These AI models have become increasingly capable of performing complex tasks, ranging from customer service automation to healthcare diagnostics and financial analysis. However, despite their remarkable capabilities, significant challenges remain in their development, testing, and deployment. A critical problem in AI development is the lack of realistic and comprehensive testing environments. Current AI systems often rely on static datasets or predefined patterns for training, which may not capture the complexity and variability of real-world scenarios. This gap leads to AI models that are inadequately prepared to handle unexpected conditions, dynamic environments, or nuanced ethical and security challenges. Furthermore, existing methods for evaluating AI performance, such as chain-of-thought prompting, static LLM evaluation techniques, human-in-the-loop (HITL) approaches, and basic guardrails, face limitations in scalability, adaptability, and safety. Incorporating human oversight in AI testing, while valuable, introduces additional problems, including the potential for bias, high costs, and inconsistency. Furthermore, the manual intervention required to test extreme or rare scenarios can be time-consuming and inefficient. Similarly, current guardrails implemented to regulate AI behavior are often static and struggle to adapt to new contexts, making them either overly restrictive or insufficiently nuanced for real-world applications. Another significant gap in the current landscape is the absence of industry-specific testing environments. AI systems developed for finance, healthcare, security, and other sensitive domains require rigorous testing that addresses the unique challenges of these fields. Existing generic testing environments fail to meet this need, leaving AI systems vulnerable to errors, security threats, and compliance issues. Moreover, the rapid evolution of AI technologies demands platforms that can adapt to emerging challenges, integrate with the latest advancements in AI services, and support continuous learning to maintain relevance over time. Current solutions are not flexible or scalable enough to meet these requirements. Additionally, the costs and resource requirements for comprehensive AI testing remain high, limiting accessibility for individual researchers and small enterprises. In light of these challenges, there is a need for an integrated platform that provides a customizable, secure, and scalable simulation environment for AI training, testing, and deployment, and improves the robustness, reliability, and safety of AI systems, enabling their responsible use across diverse real-world applications

### SUMMARY

The present invention introduces a comprehensive simulation platform designed for the development, testing, and deployment of large language models (LLMs) and LLM agents. It addresses multiple challenges in AI, including the lack of realistic training environments, difficulties in safe testing, inadequate tools for adversarial testing, and industry-specific complexities. By providing highly realistic, customizable simulation environments, the present invention allows AI models to be trained in scenarios closely resembling real-world conditions, enhancing their adaptability and robustness. A key advantage of the present invention is its modular design. It consists of essential components: the simulation environment, the AI agent, and a wrapper that acts as an intermediary between the environment and the agent. This triad enables a separation of concerns, allowing different environments and agents to be swapped without affecting the overall system. The simulation environment defines the state space, action space, transition dynamics, and reward functions, adhering to Markov Decision Process (MDP) principles. The AI agent implements decision-making, while the wrapper ensures compatibility between the environment and agent, facilitating a flexible, scalable, and modular AI system.

The present invention also supports various execution modes (sequential, parallel, and node-based) to optimize performance for different computational resources and problem structures. Its modularity allows for hierarchical AI design, decomposing complex behaviors into reusable components. Error handling, input/output processing, logging, monitoring, and API integration further enhance the system's robustness, adaptability, and scalability. Additionally, the platform offers advanced features for ethical auditing, bias detection, regulatory compliance, and industry-specific simulations, making it suitable for sensitive fields like healthcare, finance, and security. The flexible infrastructure supports external AI services, allowing integration with state-of-the-art AI capabilities. It promotes collaboration among AI development teams, mitigates high costs through a cloud-based model, and incorporates continuous learning to ensure the AI systems remain current. This invention stands out by offering a secure, comprehensive, and scalable testing environment for AI, thus enabling more reliable, responsible, and adaptive AI deployments across various industries.

In a specific embodiment, the system describe a versatile platform designed for the development, testing, and deployment of artificial intelligence (AI) agents within a dynamic simulation environment. The core of the system includes a simulation environment that manages state transitions, processes actions, and provides feedback to the AI agent. The AI agent is configured to interact with the environment, processing input states and generating actions based on a defined policy. To facilitate this interaction, the system employs a wrapper that acts as an interface, converting simulation states into formats suitable for the agent and translating the agent's outputs into executable actions for the environment. Modular components decompose the agent's behavior into smaller, manageable units, allowing for hierarchical decision-making. The system supports various execution modes, including sequential, parallel, and node-based patterns, optimizing the processing of these components according to specific needs. An error-handling mechanism is in place to detect and manage exceptions, ensuring smooth operation of the system. The configuration module manages environment variables and system parameters, setting up the AI agent, simulation environment, and wrappers. Input and output processing methods are incorporated to handle various data types, including text, numerical values, and images, to maintain compatibility between the agent and the environment. Additionally, a logging and monitoring module records states, actions, and transitions during the simulation, providing valuable data for analysis and debugging. The system also features an API integration module that interfaces with external AI services, such as natural language processing and computer vision APIs, enhancing the AI agent's functionality. The system further elaborates on these features, specifying aspects such as the simulation environment's ability to reset for multiple training sessions, the execution module's support for node-based structures, the wrapper's handling of various data formats, and the extensibility provided by the API integration module. Together, these features present a flexible, modular framework that enables AI agents to learn, adapt, and optimize performance within a variety of simulation environments.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic representation showcasing a system environment within which different embodiments of the present invention can be implemented and operationalized.

FIG. 2 is a block diagram that illustrates various components and functionalities of an AI model, in accordance with an embodiment of the present invention.

FIG. 3 is a diagram that illustrates a flowchart of a method for developing, testing, and deploying large language models (LLMs) and LLM agents, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted in one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

The invention will now be described with reference to the accompanying drawings which should be regarded as merely illustrative without restricting the scope and ambit of the present invention.

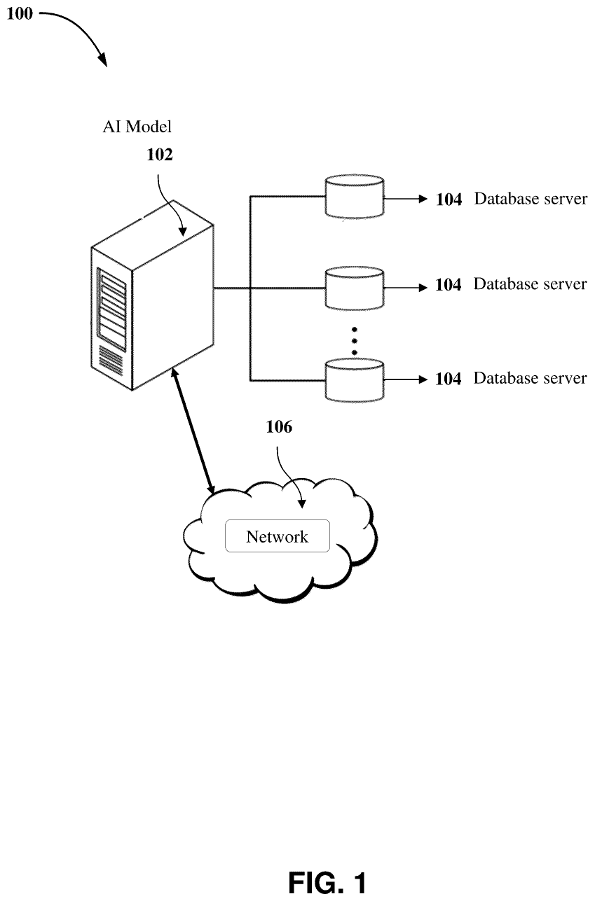

FIG. 1 is a schematic representation showcasing a system environment 100 within which different embodiments of the present invention can be implemented and operationalized. The system 100 includes an AI model 102 and a database server 104 that can communicate via a communication channel such as a network 106. The AI model 102 may be hosted over an application server (not shown) or the database server 104 or on a standalone computing device (not shown).

The AI model 102 is a highly versatile and adaptable component designed to interact seamlessly with various simulation environments, thereby enabling the comprehensive testing, development, and deployment of large language models (LLMs) and AI agents. The AI model 102 can be implemented as an LLM or a more specialized AI agent capable of performing complex decision-making tasks, processing input from the simulation environment, and generating context-aware outputs. It serves as the core decision-making entity within the system, facilitating the development of robust AI applications. In one embodiment, the AI model 102 is structured to support a modular design, allowing it to incorporate multiple subagents and components that perform specific functions. These components can be layered hierarchically to break down complex behaviors into manageable, reusable units, thereby facilitating scalability and maintainability. For instance, subagents within the model may be designed to handle different aspects of decision-making, such as natural language processing, object recognition, or interaction with external APIs. The modular nature of the AI model 102 enables developers to fine-tune each component separately, allowing for more targeted testing and continuous improvement.

The AI model 102 can also embody various execution modes, such as sequential, parallel, or node-based execution, as specified in the execution modes of the simulation environment. In sequential mode, the model 102 processes input data in a step-by-step manner, ensuring that each component's output informs the next component's input. In parallel mode, multiple components within the AI model 102 can operate simultaneously, allowing for more efficient processing of complex simulations. In node-based mode, the AI model 102 can represent its internal operations as a directed acyclic graph, enabling more sophisticated workflows that accommodate dependencies between various decision-making processes. This flexibility in execution modes allows the AI model 102 to adapt to different computational requirements and problem structures, enhancing its utility across diverse scenarios.

Another essential feature of the AI model 102 is its ability to integrate external AI services via APIs, such as those provided by Anthropic, OpenAI, or other AI service providers. This integration allows the AI model 102 to leverage advanced, pre-trained AI capabilities without the need to reimplement them from scratch, thereby significantly extending its range of functionalities. For example, the AI model 102 can call on external services for specific tasks, like generating natural language responses or performing complex data analysis, and then use the results within the simulation environment. This capability ensures that the AI model 102 remains current with the latest advancements in AI technology, maintaining its relevance and adaptability. In an embodiment, the AI model 102 is further equipped with error-handling mechanisms to enhance its robustness and reliability within the simulation environment. It can detect, manage, and report various types of errors using custom exceptions to ensure smooth operation. The error-handling system is integral to the AI model's 102 continuous learning capabilities, as it allows the model to identify potential issues, adjust its behavior, and refine its decision-making processes over time. This adaptability is crucial for AI systems operating in complex and dynamic environments, where unforeseen circumstances and edge cases are likely to arise. In an embodiment, input and output processing is another key aspect of the AI model 102. It includes methods for converting data between the simulation environment's state and the AI agent's input/output formats. These methods handle various data types, such as text, images, JSON, and other formats, to ensure seamless interaction between the AI model 102 and its surroundings. The AI model 102 can process simulation states, extract relevant information, and generate appropriate actions or responses that are fed back into the simulation environment, enabling iterative and dynamic interactions. This continuous loop of input-output processing allows the AI model 102 to adapt its strategies based on real-time feedback from the simulation, contributing to more accurate and context-aware decision-making.

In an embodiment, the AI model 102 may include advanced capabilities for adversarial testing, ethical auditing, and bias detection. By utilizing sophisticated algorithms, it can identify potential vulnerabilities in its own decision-making processes, such as susceptibility to adversarial attacks or inherent biases in its outputs. This feature is particularly valuable in sensitive applications, such as healthcare, finance, and security, where ethical considerations and regulatory compliance are paramount. The AI model 102 can generate reports or trigger alerts when it detects anomalies or behaviors that deviate from predefined ethical or security standards, thus supporting responsible AI development and deployment. In an embodiment, the AI model 102 is further designed to be highly configurable, with its behavior and parameters adjustable via various settings and environmental variables. During the initialization process, the AI model 102 loads these configurations to tailor its operations to the specific requirements of the simulation environment. This flexibility allows the AI model 102 to be deployed across multiple domains, including industry-specific simulations, enhancing its versatility. Furthermore, the model's continuous learning capability enables it to evolve over time, adapting to new scenarios, emerging challenges, and user-defined objectives, thus ensuring its long-term utility and effectiveness.

The database server 104 is a storage device that helps in supporting the operations of the AI model 102 and the simulation environment. It acts as a central repository for storing, managing, and retrieving the extensive datasets and information necessary for the functioning of the AI model 102 and the various components of the simulation platform. This includes a wide range of data types, such as training datasets, simulation states, historical interactions, logging information, and configurations required for AI agent behavior, execution modes, and environment settings. The database server 104 facilitates real-time data access, ensuring that the AI model 102 can swiftly obtain the information needed for processing inputs, making decisions, and generating outputs during simulation runs. The database server 104 also maintains detailed logs and records of the AI model's 102 interactions within the simulation environment. This logging is crucial for monitoring system performance, debugging, and conducting post-simulation analysis. For instance, it stores data points representing each interaction step in the simulation loop, such as state transitions, actions taken, rewards received, and resulting outcomes. This comprehensive logging capability enables developers and researchers to assess the AI model's 102 decision-making processes, identify potential biases or anomalies, and refine model behavior to improve robustness and ethical compliance. Furthermore, the database server 104 supports the implementation of auditing features, where historical data can be analyzed to ensure that the AI model 102 adheres to established ethical guidelines and regulatory standards.

In another embodiment, the database server 104 may store pre-trained models, configurations, and modular components that make up the AI model 102. This modular storage allows for flexible reconfiguration of the AI model 102, where different components can be loaded, swapped, or updated as needed without altering the core architecture of the system. The database server 104 also facilitates the integration of external AI services by storing API keys, authentication details, and other necessary information for seamless access to external resources, ensuring the AI model 102 can leverage the latest advancements in AI technologies. Additionally, the database server 104 supports multi-user access, enabling collaborative development efforts by allowing multiple developers to interact with the simulation environment, test models, and review stored data. Thus, the database server 104 is an essential component of the present invention, providing a robust and scalable backend infrastructure that supports the data-driven operations of the AI model 102 and the simulation environment. By centralizing data management, it enables real-time data processing, detailed performance monitoring, collaborative development, and integration with external services, all of which contribute to the platform's ability to develop, test, and deploy AI models 102 effectively across various applications and industries.

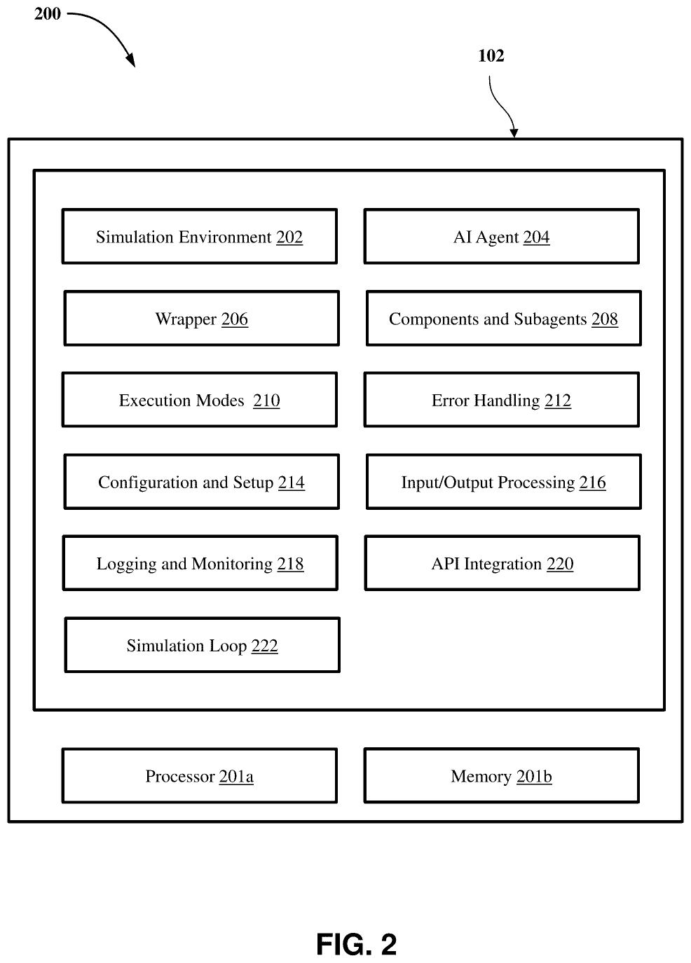

FIG. 2 is a block diagram 200 that illustrates various components and functionalities of an AI model 102, in accordance with an embodiment of the present invention. As shown, it includes simulation environment 202, AI agent 204, wrapper 206, components and subagents 208, execution modes 210, error handling 212, configuration and setup 214, input output processing 216, logging and monitoring 218, API integration 220, and simulation loop 222. There is further shown a processor 201a and a memory 201b. The processor 201a and the memory 201b are critical hardware components that collectively form the computational backbone of the system, enabling the execution of various functionalities within the simulation environment 202, AI agent 204, wrapper 206, and other components.

In an embodiment, the processor 201a, often referred to as the central processing unit (CPU) or a more specialized processor such as a Graphics Processing Unit (GPU), may be responsible for executing the complex computations and algorithms necessary for the simulation environment, AI agent behaviors, and other associated operations. It orchestrates the processing of input data, manages state transitions within the simulation, runs the AI agent's decision-making algorithms, and executes the control logic for error handling, logging, and monitoring. In this context, the processor 201a handles intensive tasks like model training, real-time simulation looping, interaction with APIs, and dynamic configuration adjustments. For high-performance demands, the processor 201a may be a multi-core CPU, GPU, or even an application-specific integrated circuit (ASIC) optimized for AI computations. Its role is to ensure that all components of the system operate efficiently, handling parallel processing tasks such as executing multiple components and subagents in different execution modes, supporting robust and real-time AI model interactions.

The memory 201b, which can include both volatile memory (RAM) and non-volatile storage (e.g., SSDs, HDDs), works in tandem with the processor 201a to facilitate data processing and storage during the execution of various system functions. The volatile memory (RAM) temporarily stores data that the processor 201a needs quick access to, such as the current state of the simulation environment, AI agent input and output, configuration settings, and intermediate computation results. This fast, temporary storage is crucial for enabling real-time interactions within the simulation loop and efficient processing of large datasets involved in AI decision-making. The non-volatile storage component of memory 201b holds persistent data, such as the stored simulation environments, AI model components, pre-trained models, configuration files, API credentials, error logs, and historical performance data. This storage ensures that critical information is retained between sessions, allowing for continuity in simulation experiments, model retraining, and system configurations. The memory 201b also supports data retrieval for logging and monitoring activities, enabling post-simulation analysis and model refinement. Together, the processor 201a and memory 201b form the foundation that drives the platform's operational capabilities. The processor 201a executes the algorithms and control logic, while the memory 201b provides both the temporary and long-term storage necessary for maintaining system states, facilitating complex computations, and enabling the seamless interaction between the simulation environment, AI agents, and other components of the invention. This synergistic relationship between the processor 201a and the memory 201b is vital for ensuring the platform's scalability, adaptability, and performance across diverse AI development and deployment scenarios.

The simulation environment 202 serves as a framework within which the AI agent operates and interacts. It is defined through various classes, each encapsulating different aspects of the simulation, such as the state space, action space, and the rules governing the environment's dynamics. These classes provide an organized structure for managing the complexity of the simulation, allowing for modularity and flexibility in defining different environments tailored to specific use cases. The simulation environment not only establishes the virtual world in which the AI agent acts but also specifies how the environment evolves in response to the agent's actions. A key responsibility of the simulation environment 202 is to manage the state of the simulation. The state space, denoted as S, represents all possible configurations of the environment at any given time. This state space is dynamic, changing as the simulation progresses and as the AI agent interacts with it. The environment provides methods for stepping through the simulation, which means it processes the agent's actions and updates the state accordingly. Each action taken by the AI agent belongs to the action space, denoted as A, which defines all the possible actions the agent can perform in the simulation. The environment uses a transition function T:S×A×S∛[0,1], which models the probability of moving from one state to another given a specific action. This transition mechanism is central to the simulation's operation, as it dictates how the environment responds to the agent's decisions and interactions. In addition to managing state transitions, the simulation environment 202 provides methods for resetting and rendering. Resetting allows the environment to be reinitialized to its starting conditions, enabling multiple trials and experiments under consistent initial states. This feature is essential for training AI agents and evaluating their performance under different scenarios. Rendering, on the other hand, refers to visualizing the current state of the environment, providing a means for developers and researchers to monitor and analyze the agent's interactions in real-time. This visual feedback is crucial for debugging, refinement, and gaining insights into the agent's behavior within the simulated context.

Mathematically, the simulation environment 202 may be expressed as E=(S,A,T,R,γ), where R:S×A→R is a reward function that assigns values to state-action pairs, guiding the agent's learning process. The discount factor γ∈[0,1] models the importance of future rewards, influencing the agent's strategy over time. By structuring the environment in this manner, the simulation adheres to the properties of a Markov Decision Process (MDP), where the probability of transitioning to the next state sₜ₊₁ depends solely on the current state sₜ and action aₜ, as defined by P(sₜ₊₁|sₜ, aₜ, sₜ₋₁, aₜ₋₁, . . . , s₀, a₀)=P (sₜ₊₁|sₜ, aₜ). This formal framework provides a rigorous basis for the AI agent's interactions and decision-making processes, allowing for the development of sophisticated learning strategies.

The AI agent 204 is the central decision-making entity, designed to interact with the simulation environment 202 and drive the system's learning and optimization processes. It is implemented in a series of classes that encapsulate its various functionalities, including processing inputs, generating outputs, and interacting with other components. The modularity provided by these classes allows for defining different types of AI agents, each capable of adapting to the unique requirements of the simulation environment 202. This implementation flexibility means that the AI agent 204 can be fine-tuned, extended, or modified to accommodate various learning algorithms, decision-making strategies, and task-specific behaviors. Within the system, the AI agent 204 is responsible for processing input data from the simulation environment 202, interpreting the current state, and generating an appropriate action or response. This interaction lies at the core of the agent's role, as it continuously engages with the environment 202, assessing changes in state and deciding the best course of action based on its learned or programmed strategy. In this process, the AI agent 204 effectively learns from the feedback it receives through its interactions, refining its responses to improve performance over time. The methods within the agent's classes manage how it receives inputs, executes its decision-making algorithms, and outputs actions back to the environment, thus creating a dynamic feedback loop essential for developing intelligent behavior. Mathematically, the AI agent 204 can be represented as a policy π, which maps states to actions or distributions over possible actions. This is expressed as π:S→A when the agent 204 selects a single action for a given state or π:S→Δ(A) when it generates a probability distribution over all possible actions, Δ(A) being the probability simplex over the action space A. In the latter case, the agent 204 may employ stochastic decision-making, where it chooses actions based on probabilistic assessments of the potential outcomes. This flexibility allows the AI agent 204 to not only operate in deterministic environments but also in more complex, uncertain scenarios where choosing the best action involves considering various possibilities and their associated probabilities. The primary function of the AI agent 204 is to implement the decision-making process within the simulation. It uses algorithms, such as reinforcement learning, supervised learning, or heuristic-based methods, to determine the optimal action for each state it encounters. For example, in a reinforcement learning scenario, the agent 204 seeks to maximize cumulative rewards by exploring different actions and learning which ones lead to favorable outcomes. As it interacts with the environment 202, it updates its policy π to reflect new insights and strategies, effectively adapting its behavior based on experience. This adaptive decision-making process is crucial for enabling the AI agent 204 to handle complex, dynamic environments, whether they involve navigating a virtual space, optimizing resource allocation, or interacting with real-world applications like autonomous vehicles or intelligent customer service.

The wrapper 206, implemented through classes like Simulation Wrapper and Base Wrapper, is a component that serves as an intermediary between the simulation environment 2020 and the AI agent 204. Its primary role is to manage the interactions between these two entities, ensuring that the data flows seamlessly and is in the appropriate format for processing. Since the simulation environment 202 and the AI agent 204 often operate using different data structures, the wrapper 206 is responsible for translating information between these formats. This translation process involves converting simulation states into a form that the agent 204 can interpret (input) and converting the agent's output into actions that can be executed within the simulation environment 202. The wrapper 206 can be mathematically represented as W:E×π→E′, where E is the original simulation environment 202, π is the AI agent 204, and E′ is a modified version of the environment 202 that is now compatible with the agent's 204 operation. This compatibility is essential because the simulation environment 202 and the AI agent 204 may use different representations of state and action spaces. For example, the environment 202 might present a complex state with numerous variables, while the AI agent 204 might require a simplified or encoded version of this state to make a decision. The wrapper 206 bridges this gap, making it possible for the agent 204 to interact effectively with the environment 202, thereby facilitating modular design and flexible integration of various AI models. The wrapper 206 performs two key transformations to achieve this compatibility. First, it uses a function f:S→S′, referred to as convert_to_agent_input, which transforms the environment's state S into a format S′ that the AI agent 204 can process. This may involve extracting relevant features from the environment's state, normalizing data, encoding information into a specific format, or filtering out unnecessary details. This transformation ensures that the agent 204 receives the input it needs to make informed decisions while abstracting away the complexities of the raw environment data. Second, the wrapper 206 employs another function g:A′→A, known as convert_from_agent_output, which takes the agent's output A′ and converts it into an action A that the environment 202 can execute. This step may involve interpreting the agent's suggested actions, scaling them to the environment's context, or mapping them to the appropriate commands within the simulation. Together, these transformations allow the AI agent 204 to communicate with and control the environment 202 effectively. By acting as a mediator, the wrapper 206 ensures that the simulation environment 202 and the AI agent 204 operate harmoniously despite potential differences in their data formats or operational constraints. This flexibility is vital for the modular design of the system, as it allows various types of AI agents 204 and simulation environments 202 to be used interchangeably. Developers can implement different wrappers tailored to specific environments or agents, making it easy to test new AI models or adapt to different simulation contexts without modifying the core architecture.

The components and subagents 208 are the building blocks that allow for the modular design of AI systems within the simulation environment 202. These elements play a crucial role in breaking down complex agent behaviors into smaller, manageable units, which can then be combined to form more sophisticated AI functions. Each component is implemented as an independent module that can be either added to the AI agent 204 itself or integrated into the simulation environment 202, providing a flexible framework for designing, customizing, and extending AI functionalities. This modular architecture facilitates the creation of hierarchical AI models, where individual components can be reused, modified, or swapped out without disrupting the overall system. The primary function of these components and subagents is to decompose complex agent behaviors into specific tasks or functions. In practice, each component is designed to handle a particular aspect of the agent's decision-making process, such as perception, action selection, or data preprocessing. For example, one component might process sensory input from the environment 202, while another component could focus on predicting the next optimal action based on the current state. By compartmentalizing these functions, developers can build intricate AI agents through a layered approach, where each layer of components contributes to the agent's overall strategy and performance. Mathematically, each component can be expressed as a function Ci:S→S′, where it transforms an input state S into an intermediate state S′. The overall behavior of the AI agent 204 is then represented as a composition of these components, denoted by π(s)=Cn ∘ Cn−1 ∘ . . . C2 ∘ C1(s). This notation reflects a hierarchical process in which each component processes the output of the previous one, ultimately leading to the agent's final decision or action. The composition allows for a layered and iterative processing of information, making it possible to handle complex tasks by sequentially applying specialized functions. This hierarchical design is beneficial for creating AI agents 204 that can adapt and respond to a wide range of scenarios, as it allows for the inclusion of various processing steps and logical conditions within the agent's decision-making pipeline. The modularity provided by components and subagents is particularly advantageous for developing flexible and scalable AI systems. Since each component operates as an independent unit, it can be individually tested, refined, or replaced without necessitating changes to other parts of the agent. Additionally, components can be reused across different agents or environments, accelerating the development process and promoting consistency in behavior across various simulations. For example, a component designed to process natural language input can be integrated into multiple AI agents, regardless of their specific end goals. This approach not only reduces the complexity of designing new AI systems but also allows developers to build upon existing components to create more advanced functionalities over time. Furthermore, subagents represent specialized components that can be integrated into the broader AI architecture to handle specific subtasks autonomously. For instance, in a simulation involving multi-step decision processes, a subagent might be responsible for executing a particular sequence of actions based on the current simulation state. The subagent's output can then feed into higher-level components, contributing to the agent's overall strategy. By incorporating subagents, the system can achieve a more nuanced and layered approach to decision-making, where different submodules work together to address various aspects of the problem at hand.

The execution modes 210 specify different patterns for running the components and subagents 208 within the AI system, thereby offering flexibility in how the agent 204 processes information and interacts with the simulation environment 202. These modes 210 provide various operational strategies, including sequential, parallel, and node-based execution, each suited to different types of tasks and computational requirements. By allowing the system to choose the most appropriate execution mode for a given scenario, it optimizes performance, resource utilization, and responsiveness. In the sequential mode, components are executed one after the other in a predefined order. This can be mathematically represented as f(C1, . . . , Cn)=Cn ∘ Cn−1 ∘ . . . ∘ C2 ∘ C1, where the output of each component is fed into the next. This mode is ideal for tasks that require step-by-step processing, where the outcome of one component directly influences the subsequent steps. In parallel execution mode, multiple components are processed simultaneously. This can be expressed as f(C1, . . . , Cn)=∪iCi, allowing for the concurrent handling of tasks that do not depend on one another. This mode is particularly useful for speeding up computation, especially when dealing with large-scale data or complex simulations that benefit from distributed processing. The node-based mode is more flexible, represented by a directed acyclic graph G=(V,E), where each node corresponds to a component and edges define the execution flow. This mode enables a more complex, non-linear sequence of operations, where different components can be executed based on specific conditions or dependencies. By defining these various execution patterns, the system can adapt to different scenarios and optimize both the decision-making process and computational efficiency.

Error handling 212 in the system is designed to manage and report errors that occur during various operations, ensuring the robustness and reliability of the AI agent 204 and simulation environment 202. It utilizes custom exceptions to identify and handle specific issues that may arise in different parts of the system. These exceptions allow the system to differentiate between various error types, making it easier to diagnose and address problems effectively. The implementation of error handling 212 relies on try-catch mechanisms wrapped around the execution of components, represented as ∀Ci, try {Ci(s)} catch (e){handle_error(c)}. This approach ensures that if an error occurs while processing a component, the system can catch the exception, handle it appropriately, and continue operation without crashing. By managing errors in this structured way, the system not only enhances its robustness but also provides valuable diagnostic information, aiding in debugging and improving the overall stability and performance of the AI models.

Configuration and setup 214 involve the management of environment variables and the initialization of key system components, including agents 204, simulations 202, and wrappers 206. This process is essential for preparing the system to operate correctly, as it defines parameters such as API keys, model settings, and simulation properties. These configurations are managed through a set of variables, denoted mathematically as θ={θ₁, θ₂, . . . , θₙ}, where each θᵢ represents a specific parameter that influences the behavior of the simulation environment E and the AI agent π. For example, environment variables might include API credentials for accessing external AI services, tuning parameters for the AI models, or settings that define how the environment should be initialized. By ensuring that all necessary parameters are correctly set up before execution, configuration and setup provide a foundation for the system's operation, allowing the components to function cohesively and optimizing the system's overall performance. This step is crucial for enabling consistent behavior across different runs, facilitating smooth integration of components, and managing changes in system configurations efficiently.

Input/output processing 216 in the system involves methods for converting data between the simulation environment 202 and the AI agent 204, enabling smooth and accurate interactions. This processing handles various data types such as text, images, and JSON, ensuring that the data is appropriately formatted for both the simulation and the agent's requirements. The input processing is represented mathematically as a function f:S→S′, where the simulation state S is transformed into a format S′ that the AI agent 204 can interpret. Similarly, the output processing is expressed as g:A′→A, where the agent's output A′ is converted into an action A that the simulation environment 202 can execute. By facilitating these transformations, input/output processing 216 ensures that the agent 204 can correctly interpret the simulation's state and respond effectively, while the simulation 202 can accurately implement the agent's decisions. This seamless interaction between the environment E and the agent π is crucial for enabling real-time feedback, iterative learning, and the overall adaptability of the system.

Logging and monitoring 218 are key components of the system that involve tracking and recording the system's state, transitions, and actions to facilitate analysis, debugging, and performance evaluation. This functionality is set up within the Base Wrapper and includes methods to log critical events, states, and actions during the simulation. Additionally, render methods are provided for visualizing the simulation state, giving a clear, real-time view of how the AI agent 204 interacts with the environment 202. Mathematically, logging can be represented as L(t)={sₜ, aₜ, rₜ, sₜ₊₁} for each timestep t, capturing the current state (sₜ), action (aₜ), reward (rₜ), and the resulting next state (sₜ₊₁). This detailed recording of interactions is invaluable for understanding the agent's decision-making process, identifying areas for improvement, and ensuring that the system operates as intended. By providing a comprehensive record of the simulation's progression, logging and monitoring support both the ongoing development and the optimization of the AI system.

API integration 220 in the system enables it to interface with external AI services to enhance its capabilities. This integration allows the AI agent 204 to leverage advanced functionalities and pre-trained models provided by these external services, enriching the agent's decision-making and interaction processes. Mathematically, this can be represented as a=API (s, (API), where the API processes the current state ss and specific parameters OAPI to return an action or result. The inclusion of external AI services through API integration significantly expands the system's flexibility, adaptability, and computational power, allowing it to access cutting-edge technologies without needing to develop these capabilities in-house. This not only streamlines the development process but also ensures the AI agent remains up to date with the latest advancements in artificial intelligence.

The simulation loop 222 is an iterative process that forms the core operation of the system, enabling the AI agent 204 to interact with the simulation environment 202 step-by-step. During each iteration, the loop progresses by taking an action, updating the environment 202, and collecting results. Specifically, the simulation loop 222 follows an algorithm where, for each timestep t up to T, the agent 204 observes the current state (sₜ), decides on an action (aₜ), and the environment 202 responds by transitioning to a new state (sₜ₊₁) while providing a reward (rₜ). This process is mathematically expressed as sₜ₊₁,rₜ=E·step (aₜ) and aₜ₊₁=π(sₜ₊₁). Throughout the loop, logging L(t)={sₜ, aₜ, rₜ, sₜ₊₁} captures these interactions for analysis and optimization. By iteratively stepping through the simulation, the loop 222 allows the AI agent 204 to learn, adapt, and refine its strategies over time, driving the system's continuous development and performance improvement.

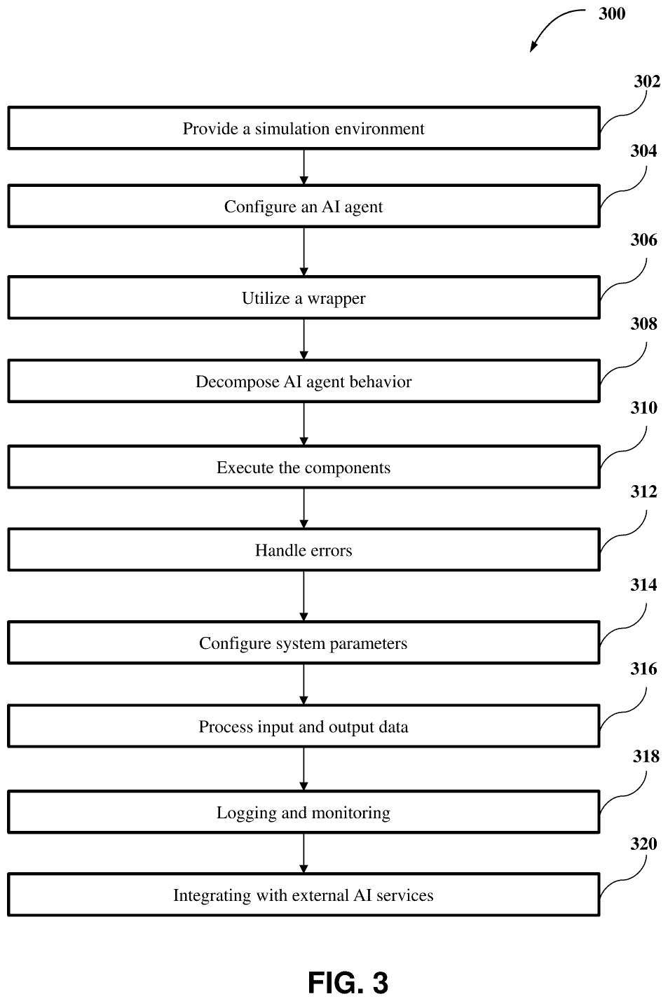

FIG. 3 is a diagram 300 that illustrates a flowchart of a method for developing, testing, and deploying large language models (LLMs) and LLM agents, in accordance with an embodiment of the present invention.

At step 302, the simulation environment 202 is provided. In an embodiment, the method includes providing the simulation environment 202, where the simulation environment 202 manages a state space, processes actions, and transitions between states.

At step 304, the AI agent 204 is configured. In an embodiment, the method further includes configuring the AI agent 204 to interact with the simulation environment 202, where the AI agent 204 processes input states from the simulation and generates output actions based on a defined policy.

At step 306, the wrapper 206 is utilized. In an embodiment, the method further includes utilizing the wrapper 206 to facilitate communication between the simulation environment 202 and the AI agent 204, where the wrapper 206 converts simulation states into agent-compatible inputs and translates agent outputs into executable actions within the simulation environment 202.

At step 308, behavior of the AI agent 204 is decomposed. In an embodiment, the method further includes decomposing the AI agent 204 behavior into modular components, where each component processes specific tasks to support hierarchical decision-making within the AI agent 204.

At step 310, the components 208 are executed. In an embodiment, the method further includes executing the components using various execution modes, including sequential and parallel modes, to optimize system operation.

At step 312, the errors are handled. In an embodiment, the method further includes handling the errors by detecting and managing exceptions during the operation of the components and interactions within the simulation environment 202.

At step 314, the system parameters are configured. In an embodiment, the method further includes configuring the system parameters through a configuration module that manages environment variables and initializes agents, simulations, and wrappers.

At step 316, the input and output data are processed. In an embodiment, the method further includes processing the input and output data between the simulation environment 202 and the AI agent 204, including the conversion of different data types for compatibility.

At step 318, logging and monitoring are performed. In an embodiment, the method further includes the logging and monitoring interactions within the simulation environment 202 to record states, actions, and rewards for analysis and debugging.

At step 320, the integration with the external AI services is performed. In an embodiment, the method further includes integrating with the external AI services through an API integration module to extend the AI agent's capabilities. The disclosed method enables the AI agent 204 to learn, adapt, and optimize its behavior within the simulation environment 202 for improved performance and decision-making.

The invention offers numerous advantages, including flexibility and modularity in AI development, allowing agents to be tailored for diverse simulation environments. The use of a wrapper ensures seamless interaction between the agent and the environment, while input/output processing manages various data formats, enhancing compatibility. Error handling improves system robustness by managing exceptions, ensuring uninterrupted operation. Modular components support hierarchical decision-making, making the AI agent's behavior more adaptable and sophisticated. The inclusion of different execution modes optimizes system performance for a variety of tasks. Furthermore, logging and monitoring provide insights into the agent's learning process, facilitating debugging and continuous improvement. API integration allows access to advanced AI capabilities, making the system expandable and up to date with the latest technologies.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A system for developing, testing, and deploying artificial intelligence (AI) agents in a simulation environment, the system comprising:
a simulation environment, implemented through classes, configured to manage a state space, action space, and transition dynamics, wherein the simulation environment provides methods for stepping through simulations, resetting, and rendering states;
an AI agent, implemented through a set of classes, configured to interact with the simulation environment by processing input states and generating output actions, wherein the AI agent operates according to a policy that maps states to actions or distributions over actions;
a wrapper, implemented as an intermediary between the simulation environment and the AI agent, configured to handle the conversion of data formats, wherein the wrapper performs key transformations including:
converting simulation states to agent-compatible inputs, and
converting agent-generated outputs into actions executable within the simulation environment;
components and subagents, defined in modular units, incorporated into the AI agent and/or the simulation environment to decompose complex agent behaviors into hierarchical structures, wherein each component performs a function and the overall agent behavior is represented as a composition of components;
execution modes, defined in execution modes classes, providing different patterns for executing components, including sequential, parallel, and node-based modes, to optimize system operation;
an error handling mechanism, using custom exceptions to detect, manage, and report errors during the operation of components and subagents;
a configuration and setup module, configured to manage environment variables, initialize agents, simulations, and wrappers, and define system parameters;
input/output processing methods, for converting between simulation states and agent inputs/outputs, handling various data types, including text, images, and JSON;
a logging and monitoring module, configured to record simulation states, transitions, actions, and rewards at each timestep, enabling analysis and debugging;
an API integration module, configured to interface with external AI services, wherein an action is obtained using the API; and
a simulation loop, iteratively stepping through the simulation process, collecting and processing results at each step, wherein the simulation loop operates according to an algorithm that updates states, actions, and logs,
wherein the system provides a comprehensive, modular framework for AI agents to learn, adapt, and optimize performance within diverse simulation environments.

2. The system of claim 1, wherein the simulation environment adheres to Markov Decision Process properties and is defined by the state space, action space, transition function, reward function, and discount factor.

3. The system of claim 1, wherein the AI agent utilizes a reinforcement learning algorithm to optimize its policy based on the rewards received from the simulation environment.

4. The system of claim 1, wherein the wrapper includes methods for converting between different data formats, including text, numerical values, images, and JSON structures, to facilitate communication between the simulation environment and the AI agent.

5. The system of claim 1, wherein the components and subagents are defined in a base component class and are configured to perform specialized tasks, such as natural language processing, object recognition, or decision-making based on environmental feedback.

6. The system of claim 1, wherein the execution modes include a sequential mode that processes components one after another in a specified order, a parallel mode that executes multiple components concurrently, and a node-based mode represented by a directed acyclic graph.

7. The system of claim 1, wherein the error handling mechanism uses try-catch methods to wrap the execution of components, enabling the system to catch and handle exceptions, log error details, and continue operation without system interruption.

8. The system of claim 1, wherein the configuration and setup module manages API keys, model parameters, and system settings through environment variables and configuration files to ensure correct initialization of agents, simulations, and wrappers.

9. The system of claim 1, wherein the input/output processing methods include feature extraction, data normalization, and encoding processes to convert raw simulation states into a structured format suitable for the AI agent's decision-making.

10. The system of claim 1, wherein the logging and monitoring module records state-action pairs, rewards, and transitions, enabling real-time visualization of the simulation process and generating logs for performance analysis and debugging.

11. The system of claim 1, wherein the API integration module is configured to interface with various external AI services, including but not limited to natural language processing, computer vision, and data analytics APIs, to enhance the agent's capabilities.

12. The system of claim 1, wherein the simulation loop includes a reset function that reinitializes the simulation environment to its initial state to conduct multiple trials and training episodes.

13. The system of claim 1, wherein the AI agent's policy supports stochastic decision-making by generating probability distributions over possible actions in the simulation environment.

14. The system of claim 1, wherein the modular design allows for the replacement or modification of individual components, subagents, or wrappers without altering the system's overall architecture or operational framework.

15. A system for artificial intelligence (AI) development, testing, and deployment, the system comprising:
a simulation environment, configured to represent a state space and facilitate interactions with an AI agent, wherein the simulation environment manages transitions, processes actions, and provides feedback;
an AI agent, configured to operate within the simulation environment, process input states, and generate output actions based on a defined policy;
a wrapper, serving as an interface between the simulation environment and the AI agent, facilitating data conversion to ensure compatibility between the simulation and the agent;
components, integrated into the system to decompose AI agent behavior into modular units for hierarchical processing;
an execution module, configured to support different patterns for executing components, including sequential and parallel modes;
an error handling mechanism, configured to detect and manage errors during the system's operation;
a configuration module, configured to set up environment variables and initialize system parameters;
an input/output processing module, configured to convert data between simulation states and agent inputs/outputs;
a logging and monitoring module, configured to record and track interactions within the system for analysis; and
an API integration module, configured to interface with external services to extend the capabilities of the AI agent,
wherein the system enables the AI agent to interact with and learn from the simulation environment, providing a flexible platform for AI optimization and adaptation.

16. The system of claim 15, wherein the simulation environment is configured to support reset operations, enabling multiple training sessions under consistent initial conditions.

17. The system of claim 15, wherein the execution module includes a node-based execution mode that allows for component processing based on a directed acyclic graph structure.

18. The system of claim 15, wherein the wrapper is configured to handle various data formats, including text, numerical values, and images, for seamless interaction between the AI agent and the simulation environment.

19. The system of claim 15, wherein the API integration module is designed to communicate with external AI services, including natural language processing and computer vision APIs, to enhance the functionality of the AI agent.

20. A method for developing, testing, and deploying artificial intelligence (AI) agents within a simulation environment, the method comprising:
providing a simulation environment, wherein the simulation environment manages a state space, processes actions, and transitions between states;
configuring an AI agent to interact with the simulation environment, wherein the AI agent processes input states from the simulation and generates output actions based on a defined policy;
utilizing a wrapper to facilitate communication between the simulation environment and the AI agent, wherein the wrapper converts simulation states into agent-compatible inputs and translates agent outputs into executable actions within the simulation environment;
decomposing AI agent behavior into modular components, wherein each component processes specific tasks to support hierarchical decision-making within the AI agent;
executing the components using various execution modes, including sequential and parallel modes, to optimize system operation;
handling errors by detecting and managing exceptions during the operation of the components and interactions within the simulation environment;
configuring system parameters through a configuration module that manages environment variables and initializes agents, simulations, and wrappers;
processing input and output data between the simulation environment and the AI agent, including the conversion of different data types for compatibility;
logging and monitoring interactions within the simulation environment to record states, actions, and rewards for analysis and debugging; and
integrating with external AI services through an API integration module to extend the AI agent's capabilities,
wherein the method enables the AI agent to learn, adapt, and optimize its behavior within the simulation environment for improved performance and decision-making.
